(19) United States
(12) Patent Application Publication
(10) Pub. No.: US 2008/0099436 A1
(43) Pub. Date: May 1, 2008

(54) ENDPOINT DETECTION FOR PHOTOMASK ETCHING

(76) Inventor: Michael Grimbergen, Redwood City, CA (US)

Correspondence Address: PATTERSON & SHERIDAN, LLP, 3040 POST OAK BOULEVARD, SUITE 1500, HOUSTON, TX, 77056, US

(21) Appl. No.: 11/844,868

(22) Filed: Aug. 24, 2007

Related U.S. Application Data
(60) Provisional application No. 60/863,490, filed on Oct. 30, 2006.

(51) Int. Cl. C23F 1/00; G01L 21/30

(52) U.S. Cl. 216/60; 156/345.25

(57) ABSTRACT

Apparatus and method for endpoint detection are provided for photomask etching. The apparatus provides a plasma etch chamber with a substrate support member. The substrate support member has at least two optical components disposed therein for use in endpoint detection. Enhanced process monitoring for photomask etching are achieved by the use of various optical measurement techniques for monitoring at different locations of the photomask.

### CROSS-REFERENCE TO RELATED APPLICATIONS

This application claims the benefit of U.S. Provisional Application No. 60/863,490 filed Oct. 30, 2006, which is herein incorporated by reference.

Additionally, the subject matter of this application is related to the subject matter disclosed in U.S. patent application Ser. No. 10/672,420, entitled “Interferometer Endpoint Monitoring Device”, filed on Sep. 26, 2003, by Nguyen, et al. (Attorney Docket Number APPM/8349), which is hereby incorporated herein by reference in its entirety. This application is also related to U.S. patent application Ser. No. 11/844,838, entitled “Endpoint Detection for Photomask Etching”, filed on Aug. 24, 2007, by Grimbergen (Attorney Docket Number APPM/11455), which is hereby incorporated herein by reference in its entirety.

### BACKGROUND

1. Field of the Invention

Embodiments of the present invention generally relate to the fabrication of integrated circuits and to the fabrication of photomasks useful in the manufacture of integrated circuits.

2. Description of the Related Art

The fabrication of microelectronics or integrated circuit devices typically involves a complicated process sequence requiring hundreds of individual steps performed on semiconductor, dielectric and conductive substrates. Examples of these process steps include oxidation, diffusion, ion implantation, thin film deposition, cleaning, etching and lithography. Using lithography and etching (often referred to as pattern transfer steps), a desired pattern is first transferred to a photosensitive material layer, e.g., a photoresist, and then to the underlying material layer during subsequent etching. In the lithographic step, a blanket photoresist layer is exposed to a radiation source through a reticle or photomask containing a pattern so that an image of the pattern is formed in the photoresist. By developing the photoresist in a suitable chemical solution, portions of the photoresist are removed, thus resulting in a patterned photoresist layer. With this photoresist pattern acting as a mask, the underlying material layer is exposed to a reactive environment, e.g., using wet or dry etching, which results in the pattern being transferred to the underlying material layer.

The pattern on a photomask, which is typically formed in a metal-containing layer supported on a glass or quartz substrate, is also generated by etching through a photoresist pattern. In this case, however, the photoresist pattern is created by a direct write technique, e.g., with an electron beam or other suitable radiation beam, as opposed to exposing the photoresist through a reticle. With the patterned photoresist as a mask, the pattern can be transferred to the underlying metal-containing layer using plasma etching. An example of a commercially available photomask etch equipment suitable for use in advanced device fabrication is the Tetra™ Photomask Etch System, available from Applied Materials, Inc., of Santa Clara, Calif. The terms “mask”, “photomask” or “reticle” will be used interchangeably to denote generally a substrate containing a pattern.

During processing, endpoint data from the etching of the photomasks may be used to determine whether the process is operating according to required specifications, and whether the desired results such as etch uniformity are achieved. Since each photomask generally has its own set of features or patterns, different photomasks being etched using the same process recipe may yield different endpoint data, thereby making it difficult to determine if the desired etch results are obtained for a specific photomask.

With ever-decreasing device dimensions, the design and fabrication of photomasks for advanced technology becomes increasingly complex, and control of critical dimensions and process uniformity becomes increasingly more important. Therefore, there is an ongoing need for improved process control in photomask fabrication, such as improved apparatus and method for generating endpoint data that would be consistent for each photomask.

### SUMMARY

Embodiments of the invention generally provide a method and apparatus for etching a substrate. The invention is particularly suitable for etching photomasks, among other substrates used vacuum processing.

In one embodiment, a method for etching a substrate is provided that includes (a) providing an etch chamber having a substrate support member, the substrate support member comprising at least a first window in a center region and a second window in a peripheral region, (b) providing a substrate on the substrate support member, (c) introducing a process gas into the etch chamber, (d) generating a plasma from the process gas for etching the substrate, (e) detecting a first optical signal through the first window and a second optical signal through the second window using an endpoint detection system, and terminating the plasma based on information obtained from at least one of the detected first and second optical signals.

In another embodiment, a method for etching a substrate includes (a) providing an etch chamber having a substrate support member, the substrate support member comprising a first window and a second window, (b) providing a substrate on the substrate support member, (c) generating a plasma from a process gas for etching the substrate, (d) providing an endpoint detection system comprising a photodetector, (e) monitoring at least one optical signal through at least one of the first window and the second window using the photodetector, and (f) terminating the plasma based on information obtained from the at least one optical signal.

In another embodiment of the invention, an apparatus for substrate etching is provided that includes a plasma etching chamber, a substrate support member inside the chamber, the substrate support member having a first window disposed in a center region and a second window disposed in a peripheral region, and an endpoint detection system operatively coupled to the chamber through the first and second windows.

In another embodiment, an apparatus for substrate etching may include a plasma etching chamber comprising a substrate support member, an endpoint detection system configured for operating in at least one of a reflection mode and a transmission mode, wherein the endpoint detection system comprises a first optical component disposed in a center region of the substrate support member and a second optical component disposed in a peripheral region of the substrate support member.

Another embodiment provides an apparatus for substrate etching that includes a plasma etching chamber, a substrate support member inside the chamber, the substrate support member having a first window and a second window disposed therein, the first window being in a center region of the support member, and an endpoint detection system operatively coupled to the chamber through one of the first and second windows.

In another embodiment, a method for etching a substrate may include providing an etch chamber having a substrate support member, the substrate support member comprising a first window in a center region and a second window in a peripheral region, providing a substrate on the substrate support member, introducing a process gas into the etch chamber, generating a plasma from the process gas for etching the substrate, detecting a first optical signal through the first window and a second optical signal through the second window using an endpoint detection system, and terminating the plasma based on information obtained from at least one of the detected first and second optical signals.

In yet another embodiment, a method for etching a substrate includes (a) providing an etch chamber having a substrate support member, the substrate support member having a first window and a second window, (b) providing a substrate on the substrate support member, (d) generating a plasma from a process gas for etching the substrate, (e) providing an endpoint detection system that includes a photodetector, (f) monitoring at least one optical signal through at least one of the first window and the second window using the photodetector, and (g) terminating the plasma based on information obtained from the at least one optical signal.

### BRIEF DESCRIPTION OF THE DRAWINGS

So that the manner in which the above recited features, advantages and objects of the invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1A illustrates a process chamber incorporating one embodiment of the present invention;

FIG. 1B illustrates a cross-sectional view of two optical configurations for endpoint monitoring according to embodiments of the present invention;

FIG. 1C is a schematic top view of one embodiment for endpoint detection;

FIG. 2 illustrates sample locations on a substrate for endpoint detection;

FIG. 3 illustrates a top view of a 6-inch substrate with peripheral locations for endpoint detection;

FIGS. 4A-C are illustrate schematically structures of several types of photomasks during fabrication;

FIG. 5 is an illustration of various optical signals used for endpoint detection; and

FIG. 6 is a flow diagram of one embodiment of a process for etching a photomask.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

The present invention provides a method and apparatus for etching a photomask substrate with enhanced process monitoring, for example, by providing for optical monitoring at different regions of the photomask. Although the discussions and illustrative examples focus on the etching of a photomask substrate, various embodiments of the invention can also be adapted for process monitoring of other suitable substrates, including transparent or dielectric substrates.

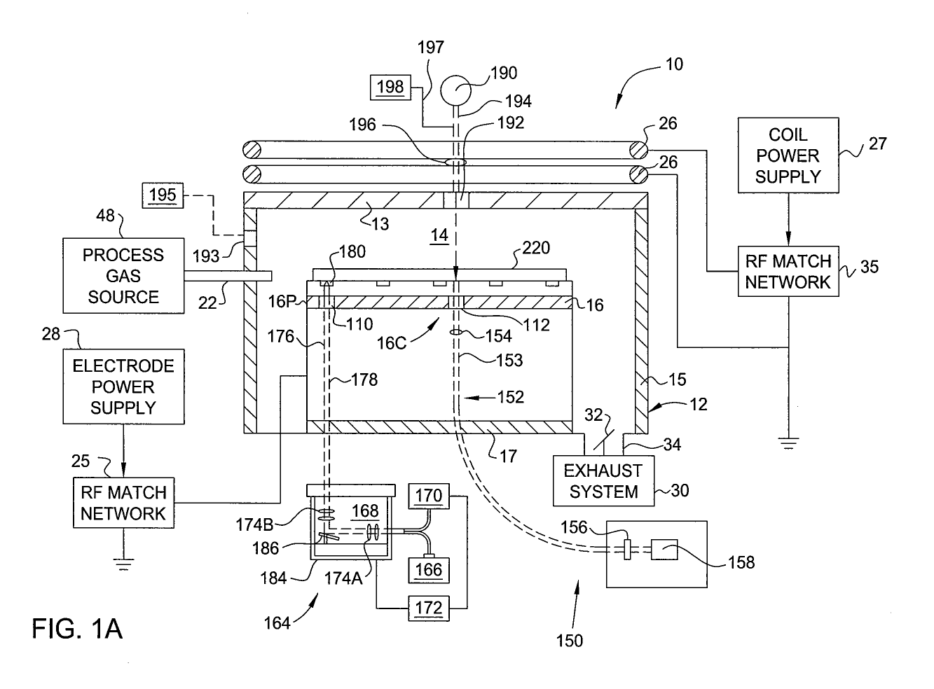

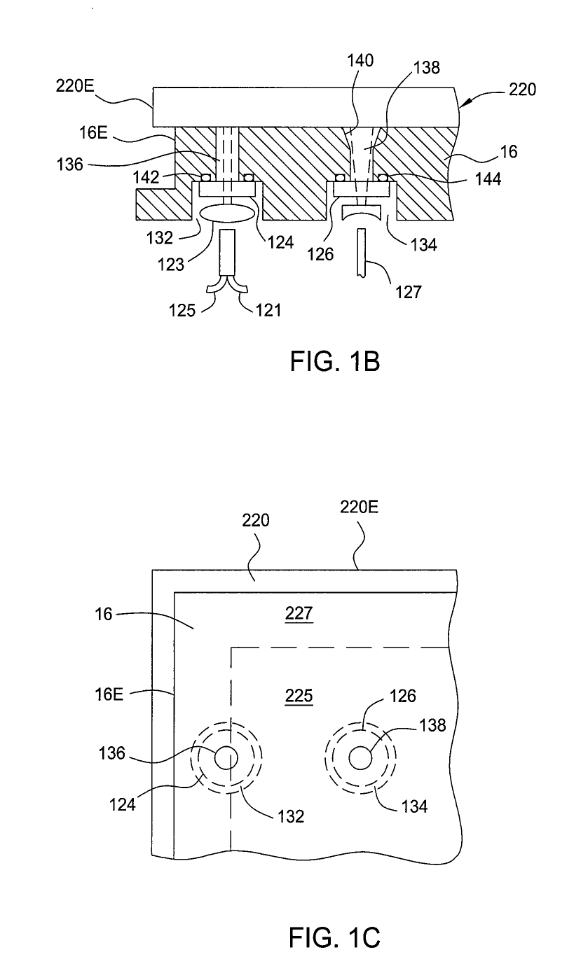

FIG. 1A is a schematic cross sectional view of a plasma etch chamber 10 in accordance with one embodiment of the invention. Suitable plasma etch chambers include the Tetra™ II photomask etch chamber or the Decoupled Plasma Source (DPS™) chamber available from Applied Materials, Inc., of Santa Clara, Calif. Other process chambers may also be used in connection with embodiments of the invention, including, for example, capacitive coupled parallel plate chambers and magnetically enhanced ion etch chambers, as well as inductively coupled plasma etch chambers of different designs. The particular embodiment of the etch chamber 10 shown herein is provided for illustrative purposes and should not be used to limit the scope of the invention. It is contemplated that the invention may be utilized in other processing systems, including those from other manufacturers.

The process chamber 10 generally includes a cylindrical sidewall or chamber body 12, an energy transparent ceiling 13 mounted on the body 12, and a chamber bottom 17. The ceiling 13 may be flat, rectangular, arcuate, conical, dome or multi-radius shaped. At least one inductive coil 26 is disposed above at least a portion of the ceiling 13. In the embodiment depicted in FIG. 1A, two concentric coils 26 are shown. The chamber body 12 and the chamber bottom 17 of the process chamber 10 can be made of a metal, such as anodized aluminum, and the ceiling 13 can be made of an energy transparent material such as a ceramic or other dielectric material.

A substrate support member 16 is disposed in the process chamber 10 to support a substrate 220 during processing. The support member 16 may be a conventional mechanical or electrostatic chuck with at least a portion of the support member 16 being electrically conductive and capable of serving as a process bias cathode. While not shown, a photomask adapter may be used to secure the photomask on the support member 16. The photomask adapter generally includes a lower portion milled to cover an upper portion of the support member and a top portion having an opening that is sized and shaped to hold a photomask. In one embodiment, the top portion of the photomask adapter has a square opening. A suitable photomask adapter is disclosed in U.S. Pat. No. 6,251,217, issued on Jun. 26, 2001, which is incorporated herein by reference to the extent not inconsistent with aspects and claims of the invention.

Process gases are introduced into the process chamber 10 from a process gas source 48 through a gas distributor 22 peripherally disposed about the support member 16. Mass flow controllers (not shown) for each process gas, or alternatively, for mixtures of the process gas, are disposed between the process chamber 10 and the process gas source 48 to regulate the respective flow rates of the process gases.

A plasma zone 14 is defined by the process chamber 10, the substrate support member 16 and the ceiling 13. A plasma is generated in the plasma zone 14 from the process gases by supplying power from a power supply 27 to the inductive coils 26 through an RF match network 35. The support member 16 may include an electrode disposed therein, which is powered by an electrode power supply 28 and generates a capacitive electric field in the process chamber 10 through an RF match network 25. Typically, RF power is applied to the electrode in the support member 16 while the body 12 is electrically grounded. The capacitive electric field, which is transverse to the plane of the support member 16, influences the directionality of charged species to provide more anisotropic etching of the substrate 220.

Process gases and etchant byproducts are exhausted from the process chamber 10 through an exhaust port 34 to an exhaust system 30. The exhaust system 30 may be disposed in the bottom 17 of the process chamber 10 or may be disposed in the body 12 of the process chamber 10 for removal of process gases. A throttle valve 32 is provided in the exhaust port 34 for controlling the pressure in the process chamber 10.

FIG. 1A further illustrates an endpoint detection system 164 operatively coupled to the process chamber 10 in accordance with one embodiment of the invention. According to embodiments of the invention, at least two optical access ports or viewports, are provided in different regions of the substrate support member 16. In one embodiment, at least one access port is provided in a non-peripheral region. In yet another embodiment, the substrate support member 16 is provided with at least one window in a center region. In the example shown in FIG. 1A, the two optical access ports comprise respectively a window 110 at a peripheral region 16P, and a window 112 at a central region 16C. The endpoint detection system 164 is configured to detect optical signals through one or more of these windows, which allows optical monitoring of various locations on a photomask substrate 220 from its backside during etching. In one embodiment, a third window (not shown) may also be provided in the peripheral region 16P of the substrate support member 16. Alternatively, different numbers of windows may be provided at other locations of the substrate support member 16.

In general, a larger window facilitates the installation of optical components within the substrate support member 16. However, for apparatus in which the substrate support member 16 is RF biased, the size of the window, especially in the central region 16C of the substrate support member 16, is selected to be sufficiently large for optical monitoring, yet small enough to avoid potential adverse impact for the RF bias. Selecting a small window also improves the lateral temperature uniformity of the support member 16. The optical access port may generally comprise a flat window made of quartz or other materials that transmit light over a broad wavelength spectrum. A more detailed discussion of different optical configurations will be provided in a later section.

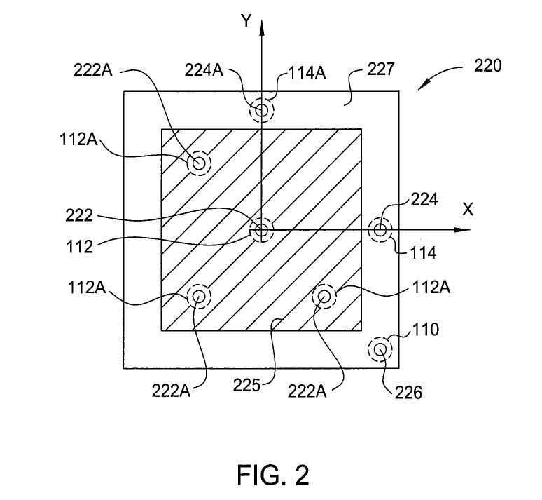

Referring first to FIG. 2, FIG. 2 illustrates schematically several locations of the photomask substrate 220 that are monitored for endpoint detection according to one embodiment of the present invention. A central region 225 of the substrate 220 may be defined as the area of the photomask that is patterned for lithographic purposes, while a peripheral region is outside of the patterned central region, and may include patterns or features utilized for endpoint or monitoring of other process parameters. Several windows disposed in the substrate support member 16 are shown in phantom. For example, when the photomask substrate 220 is centrally disposed with respect to the substrate support member 16, optical access through window 112 allows monitoring of an area 222 around the center of the photomask 220, while areas 224 and 226 in a peripheral region 227 of the photomask 220 can be monitored through windows 114 and 110, respectively. In one embodiment, monitored areas 224 and 226 are located respectively along one side and at a corner of the photomask 220. In another embodiment, the monitored area 224 is located on one side of the photomask 220, e.g., at a midpoint of the side, along a x-direction with respect to the center of the photomask 220, while another area 224A located on an adjacent side of the photomask 220, e.g., along a y-direction with respect to the center of the photomask 220, is monitored through another window 114A. Optical signals obtained through windows such as 112, 114 and 114A can be used to obtain center to edge etch uniformity along the x- and y-directions, or more generally, along directions that are perpendicular to each other.

One or more windows 112A may also be provided in the substrate support member 16 to allow for monitoring of different areas such as 222A in the central region 225 of the photomask 220. The additional windows 122A, 114A facilitate determination of an edge to center etch profile. For example, information regarding process uniformity, such as the edge to center etch profile, can be obtained by comparing the endpoint results at different regions or locations of the photomask 220, e.g., based on signals from areas 222, 224 and 224A. The windows may also be used for ensuring that at least one window 122, 122A is below a feature being etched.

Referring back to FIG. 1A, the endpoint detection system 164 comprises optical setup for operating in reflection or transmission modes, and is configured for different types of measurements such as reflectance or transmittance, interferometry, or optical emission spectroscopy. Depending on the application of interest, e.g., the material layers or substrate structure being processed, endpoints may be detected based on a change in the reflectance or transmittance intensities, the number of interference fringes, or changes in optical emission intensities at specific wavelengths, or a combination thereof.

The reflection mode of operation allows reflectance (or reflectometry) and interferometric measurement to be performed. The endpoint system 164 generally comprises an optical source 166, a focusing assembly 168 for focusing an incident optical beam 176 from the optical source 166 onto an area or spot 180 on the backside of substrate 220, and a photodetector 170 for measuring the intensity of a return optical beam 178 reflected off the area 180 of the substrate 220. The photodetector 170 may generally be a single wavelength or multi-wavelength detector, or a spectrometer. Based on the measured signal of the reflected optical beam 178, a computer 172 calculates portions of the real-time waveform and compares it with a stored characteristic waveform pattern to extract information relating to the etch process. In this case, the calculation may be based on slope changes or other characteristic changes in the detected signals, either in reflection or transmission mode, for example, when a film is etched through. Alternatively, the calculation may be based on interferometric signals as the depth of a trench or the thickness of a film changes during etching. In other embodiments, more detailed calculations may be performed based on reflection and transmission data obtained over a wide spectrum in order to determine the depth or thickness at any point in the etch process, or to determine the lateral dimensions of the features being etched.

The light source 166 may be monochromatic, polychromatic, white light, or other suitable light source. In general, the optical signal from the reflected beam 178 may be analyzed to extract information regarding the presence or absence of a layer (e.g., metal-containing layer), or the thickness of certain material layers within the area 180. The intensity of the incident light beam 176 is selected to be sufficiently high to provide a return beam 178 with a measurable intensity. In one embodiment, the light source 166 provides polychromatic light, e.g., from an Hg—Cd lamp or a light emitting diode (LED), which generates light in a wavelength range from about 200 nm to about 800 nm, or about 400 to 800 nm, respectively. The polychromatic light source 166 can be filtered to provide an incident light beam 176 having selected frequencies. Color filters can be placed in front of the light detector 170 to filter out all wavelengths except for the desired wavelength of light, prior to measuring the intensity of the return light beam 178 entering the light detector 170. The light can be analyzed by a spectrometer (array detector with a wavelength-dispersive element) to provide data over a wide wavelength range, such as ultraviolet to visible, from about 200 nm to 800 nm. The light source may be configured to operate in a continuous or pulsed mode. With continuous detection, it is preferable to have a light source with an output intensity that is higher than that of the plasma emission. In the case of a light source with multiple wavelength outputs, one can select a wavelength whose intensity is higher than that of the corresponding wavelength from the plasma. For pulsed mode operation, such requirements of the light source intensity may be relaxed, as long as the detector is not saturated by the intensity from the light source and plasma.

Various light source options are available for pulsed mode operation. For example, the light source 166 may be any suitable source that provides a steady or continuous radiation output. A shutter (not shown) can be provided to block and unblock the output beam from the light source 166 so as to provide alternate beam off/on cycles for signal detection. A signal acquired during the beam “on” period will include contributions from the plasma emission and the signal induced by the light source 166, while a signal acquired during the beam “off” period will correspond to the plasma emission. Subtracting the beam “off” signal from the beam “on” signal can result in improved measurement because potential interference from the plasma emission can be eliminated. Such a data subtraction routine can be provided as part of algorithm associated with the endpoint detection system.

Pulsed mode operation may also be achieved by configuring the light source 166 to be switched on and off in alternate cycles. In general, the shuttering or switching of the light source can be performed at various combinations of duty cycles and signal acquisition times, e.g., with the light source duty cycle selected to match that of the detector duty cycle for background subtraction. The light source intensity may also be adjustable to avoid saturating the detector, e.g., a charge-coupled device (CCD). If the pulse duration is shorter than the detector sampling time, the lamp may be pulsed a number of times to form a higher total intensity by integration. In one embodiment, a 50 percent duty cycle is used.

Alternatively, unequal sampling periods may also be used for background subtraction. For example, the sampling time for the detector, e.g., a CCD, can be kept short during the light source “on” period, followed by a longer sampling time during the light source “off” period, during which the background plasma emission is collected. This may be useful for reducing the noise in the background plasma emission if the emission itself is used as a secondary signal, e.g., as in transmission monitoring.

The selection of the signal acquisition time and the light source “on” period may depend on the specific application and the intensity of the light source. In general, using a light source with a relatively low intensity output will require a longer signal acquisition time. In one embodiment, the beam “on” period can range from about 0.1 second to about 2 seconds.

The light source 166 may be a monochromatic source that provides optical emission at a selected wavelength, for example, a He—Ne or ND-YAG laser, or a solid state source such as a light emitting diode (LED). Other options include various discharge lamps such as hydrogen (H₂), deuterium (D₂), vapor lamps such as those disclosed in Grimbergen, U.S. Pat. No. 6,534,756, or hollow cathode lamps, with radiation outputs at multiple wavelengths. In one embodiment, the light source 166 includes a number of LEDs providing radiation outputs at different wavelength regions. For example, the light source 166 may include at least one of the following: a LED in the ultraviolet (UV) region, a LED in the infrared (IR) region, and a LED with broadband (e.g., white light) output, or any combinations thereof. Using a combination of LEDs with different output wavelengths, e.g., 370 nm (UV), 390 nm (UV), 400-700 nm (white), 800 nm (IR), 1300 nm (IR), 1500 nm (IR), spectral output from the UV to the IR region can be achieved, e.g., from about 350 nm to about 1500 nm. In this case, the light source 166 can be provided with an output fiber bundle with fibers coupling to respective LEDs.

One or more convex focusing lenses 174a, 174b may be used to focus the incident light beam 176 to the area 180 on the substrate surface, and to focus the return light beam 178 back on the active surface of light detector 170. The area 180 should be sufficiently large to compensate for variations in surface topography of the substrate 220 and device design features. This enables detection of etch endpoints for high aspect ratio features having small openings, such as vias or deep narrow trenches, which may be densely present or more isolated. The area of the return light beam should be sufficiently large to activate a large portion of the active light-detecting surface of the light detector 170. The incident and return light beams 176, 178 are directed through a transparent window 110 in the process chamber 10 that allows the light beams to pass in and out of the processing environment. Although lenses 172a and 174b are shown in FIG. 1A as mounted away from the window 110, in practice, they may also be mounted close to the window 110, as shown in FIG. 1B. It is also understood that the incident and return light beams 176, 178 can generally be coupled via optical fibers to the endpoint detection system 164. The use of fiber optics for coupling light beams to and from the windows also allows electrical isolation to be maintained between the substrate support member 16 and the detector electronics.

The diameter of the beam spot 180 is generally about 2 mm to about 10 mm. However, if the beam spot 180 encompasses large isolated areas of the substrate containing only a small number of etched features, it may be necessary to use a larger beam spot in order to encompass a greater number of etched features. The size of the beam spot can therefore be optimized, depending on the design features for a particular device. If the signal is sufficient, a large beam spot or field of view will enable process control without precisely matching the position of the substrate support hole and the etched area of the substrate giving rise to the signal.

Optionally, a light beam positioner 184 may be used to move the incident light beam 176 across the substrate 220 to locate a suitable portion of the substrate surface on which to position the beam spot 180 to monitor an etching process. The light beam positioner 184 may include one or more primary mirrors 186 that rotate at small angles to deflect the light beam from the light source 166 onto different positions of the substrate surface. Additional secondary mirrors may be used (not shown) to direct the return light beam 178 on the photodetector 170. The light beam positioner 184 may also be used to scan the light beam in a raster pattern across the backside of the substrate 220. In this embodiment, the light beam positioner 184 comprises a scanning assembly consisting of a movable stage (not shown), upon which the light source 166, the focusing assembly 168 and the detector 170 are mounted. The movable stage can be moved through set intervals by a drive mechanism, such as a stepper motor or galvanometer, to scan the beam spot 180 across the substrate 220.

The photodetector 170 comprises a light-sensitive electronic component, such as a photovoltaic cell, photodiode, or phototransistor, which provides a signal in response to a measured intensity of the return light beam 178. The signal can be in the form of a change in the level of a current passing through an electrical component or a change in a voltage applied across an electrical component. The photodetector 170 can also comprise a spectrometer (array detector with a wavelength-dispersive element) to provide data over a wide wavelength range, such as ultraviolet to visible, from about 200 nm to 800 nm. The return light beam 178 undergoes constructive and/or destructive interference which increases or decreases the intensity of the light beam, and the light detector 170 provides an electrical output signal in relation to the measured intensity of the reflected light beam 178. The electrical output signal is plotted as a function of time to provide a spectrum having numerous waveform patterns corresponding to the varying intensity of the reflected light beam 178.

A computer program on a computer system 172 compares the shape of the measured waveform pattern of the reflected light beam 178 to a stored characteristic (or reference) waveform pattern and determines the endpoint of the etching process when the measured waveform pattern is the same as the characteristic waveform pattern. As such, the period of the interference signal may be used to calculate the depth and etch rate. The program may also operate on the measured waveform to detect a characteristic waveform, such as, an inflection point. The operations can be simple mathematic operations, such as evaluating a moving derivative to detect an inflection point. Although FIG. 1A shows the computer system 172 connected to the endpoint system 164, it is also used for processing data from other endpoint detectors in the system.

FIG. 1A is meant to illustrate the relative positioning of the optical access ports or windows 110 and 112 in the substrate support member 16. A close-up cross-section view of two alternative optical configurations is shown schematically in FIG. 1B. The substrate support member 16 is provided with recessed portions 132 and 134, which are separately connected to openings or channels 136 and 138 to allow optical access to the backside of substrate 220. The recess portions 132 and 134 are provided with O-rings and grooves 142 and 144 for vacuum sealing to windows 124 and 126, respectively. One configuration illustrates endpoint detection based on reflection measurements through window 124, with incident light in a fiber 121 being focused by lens 123 onto the substrate 220. The signal returning from the backside of substrate 220 is then collimated by the lens 123 and coupled via a fiber 125 to the endpoint detection system 164. Different focal lengths may be used for lens 123, and in one embodiment, a focal length of about 15 mm is used. In other embodiments, collimating lens 123 may be omitted, in which case, fibers 121 and 125 can be mounted up against the window 124. Depending on the specific measurements and optical configurations, fibers 121 and 125 may refer to either a single fiber or a fiber bundle (having more than one fiber). The use of multiple fibers offers additional capabilities, including, for example, improved signal strengths and simultaneous sampling of different areas.

Another configuration illustrates endpoint detection based on transmission measurements through window 126. A transmission signal, e.g., plasma emission or external light source, passes through window 126 and is collected by fiber 127 for detection. As shown in FIG. 1B, the opening or channel 138 is provided with a tapered or conical section 140 near the top surface of the substrate support member 16. The conical section 140 has a larger diameter (or lateral dimension) at the top compared to the interior portion, i.e., the portion closer to the recessed portion 134. This design has an advantage of providing a wider field of view or sampling area at the substrate 220, without requiring the use of a larger size window 126. In one embodiment, the conical section 140 is shaped to provide a field of view with a full angle of about 25° for use with a fiber having a numerical aperture of about 0.22. The field of view can also be changed by adjusting the distance between the fiber 127 and the window 126. Optionally, a diverging lens may also be used for coupling the emission to the fiber 127.

The various optical components are mounted and secured inside the substrate support member 16 using a variety of hardware known to one skilled in the art, and have been omitted in FIG. 1B for the sake of clarity. Since the substrate support member 16 is made of a conductive material, e.g., anodized aluminum, the mounting hardware are either non-conducting or otherwise insulated from the substrate support member 16. The size of the openings 136, 138 and recessed portions 132, 134 may vary according to specific design and/or process needs, for example, taking into account factors such as the optical beam spot size, desired sample areas, minimal impact on RF bias, and so on. For example, the recessed portions 132, 134 may have diameters ranging from several millimeters (mm) to several centimeters (cm), while openings 136, 138 may have diameters up to about one centimeter. In one embodiment, an opening with a diameter of about 7 mm is used with a beam spot size of about 2 mm. Other design alternatives may include providing a conductive grid or conductive transparent coating on the windows in order to minimize potential impact on the RF bias to the substrate support member 16.

The endpoint detection system 164 can be configured to detect patterns disposed in any region of the substrate surface. Depending on the specific endpoint detection technique, the patterns on the substrate may be any suitable device features on the photomask, or they may be test patterns with specific feature design or dimension to facilitate endpoint detection. For example, such test patterns may be line/space patterns with a single or varying pitch and/or linewidth.

FIG. 1C is a schematic top view showing one embodiment of the relative positions of openings 136, 138, windows 124, 126, substrate support member 16 and the substrate 220. The side or edge 220E of the substrate 220 extends beyond the edge 16E of the substrate support member 16. As shown, the separation between the peripheral region 227 and the central region 225 of the substrate 220 is indicated by a dashed line. Opening 138 is used for monitoring endpoint in the central region 225. Although opening 136 covers an area that includes both the peripheral region 227 and the central region 225 of the substrate 220, it can still be used for endpoint monitoring purposes, e.g., to obtain etch uniformity information, among others. Alternatively, if the endpoint monitoring through opening 136 is based on a signal from a specific test pattern provided in the peripheral region 227, such endpoint monitoring can be effectively performed, as long as the detected signal is substantially free from interference that might arise from features in the central region 225 that are within the field of view of opening 136. In general, to avoid undesirable interference, test patterns are provided at locations sufficiently separate from features in the central region 225 of the substrate 220. In one embodiment, one or more test patterns are provided at distances up to about 10 mm from the edge 220E of the substrate 220, and openings are provided at corresponding locations of the substrate support member 16 for endpoint monitoring.

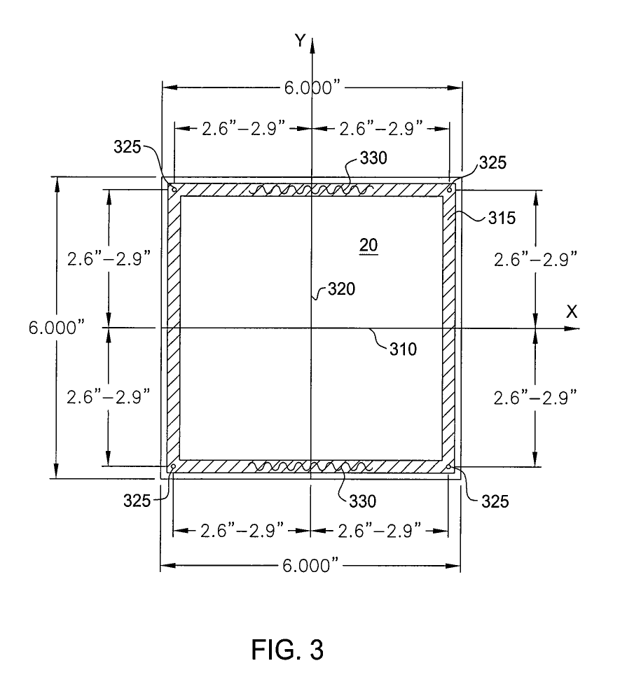

FIG. 3 illustrates a top view of a 6-inch square substrate with various locations in the peripheral region for endpoint monitoring. In one embodiment, endpoint detection is performed based on the monitoring of one or more test patterns 330 disposed in the peripheral region 315 or at the corners 325 of the substrate, and the endpoint detection system 164 may be disposed directly below these regions of the substrate. For example, with a 6 inch by 6 inch substrate, the windows of the endpoint detection system 164 may be disposed at least about 2.6 inches, such as between about 2.6-2.9 inches, from a horizontal center line 310 of the substrate 220 and at least about 2.6 inches, such as between about 2.6-2.9 inches, from a vertical center line 320 of the substrate 220, as illustrated in FIG. 3. The window 112 is generally located at the intersection of lines 310, 312. Windows 122A are generally located less than 2.6 inches from the center in the plane of the substrate support member 16 for monitoring areas within the central region 225 of the substrate. In one embodiment, the test pattern has a size that is about the same or larger than the beam spot.

The light beams reflected from each substrate having the same test patterns are configured to have the same waveform patterns when detected by the endpoint detection system 164. In this manner, the waveform patterns derived from the same test patterns may be used to determine whether the chamber is operating according to a particular process recipe, and whether the desired etch results are obtained for different substrates.

While test patterns or various dimensions and/or designs can readily be provided in the peripheral region, the placement of such patterns in the central region of the photomask is much more restrictive. Thus, the availability of features for endpoint monitoring in the central region usually depend on the device design and layout on the photomask. If the monitored area does not provide sufficiently strong optical signal for monitoring, e.g., due to insufficient open areas, alternative optical configurations may be used to increase the field of view or to provide multiple sampling areas. Such alternatives may include the use of optical components, e.g., lenses and fibers, with higher numerical apertures (NA), including fibers with tapered ends or the use of fiber bundles to sample different areas. The use of larger NA optics allows the sampling area to be increased without necessarily increasing the size of the window. The use of multiple fibers (e.g., fiber bundle) allows optical signals to be monitored at different areas of the substrate. Depending on the specific features and detection techniques, signals from these different areas, such as different locations across the center region of the substrate, may be added together to provide an improved signal, or the different signals may be compared with each other and the best one selected for use in endpoint detection. In most embodiments, the collection optics is configured to sample optical signals in a direction substantially perpendicular to the plane of the substrate. In another embodiment, the collection optics may also sample signals from an oblique view angle, i.e., not perpendicular to the substrate. This oblique viewing configuration will also result in an increased sampling area compared to the perpendicular configuration using the same collection optics.

In the transmission mode of operation, the endpoint detection system 164 monitors the transmittance (e.g., total light intensity) or optical emission signals (e.g., wavelength-resolved emission) as a function of time. In one embodiment, the plasma in the chamber 10 serves as the light source for the optical emission monitoring. This configuration has the advantage of a simpler optical setup compared to the reflection mode, because it does not require an external light source and only one optical fiber is needed.

The plasma emission typically includes light at discrete wavelengths that are characteristic of various species present in the plasma. For example, emission can be monitored at one or more wavelengths that correspond to one or more etchant/reactant or etch product species. At the etch endpoint, e.g., when a certain material layer is completely etched and an underlying layer is exposed, the monitored emission intensity changes according to whether there is an increase or decrease of the emitting species being monitored. In general, the optical emission detection apparatus 150 of the endpoint detection system 164 comprises light collection assembly 152, a wavelength dispersive element 156 and a photodetector 158. In one embodiment, the light collection assembly 152 includes an optical fiber 153, and optionally, a lens 154 for coupling the optical signal to the fiber 153. The wavelength dispersive element 156 may be a spectrometer for separating the optical signal 178 into its component wavelengths. In other embodiments, the light collection optical assembly 152 may include various bulk optical components such as lenses and mirrors, and the wavelength dispersive element 156 may be a variety of filters to pass a selective range of wavelengths. Depending on the specific arrangements, the photodetector 158 may be configured to detect optical signals at a specific wavelength, or it may detect the signals at different wavelengths simultaneously. Suitable photodetectors may include a photodiode, photomultiplier tube or a charged-coupled device, among others.

Although the embodiment in FIG. 1A shows different optical signals from windows 110 and 112, e.g., reflection and transmission signals, coupled to different optical components of the endpoint detection system 164, the two signals monitored through windows 110 and 112 may also be the same type of optical signals, e.g., both being reflectance signals or transmittance signals, and so on. In addition, the two optical signals from windows 110 and 112 may be coupled to the same photodetector. For example, if an imaging photodetector is used, a plasma emission signal from one window may be imaged onto a first set of detector elements or pixels of the detector, and the other emission signal from the second window may be imaged onto a second set of detector elements or pixels of the same detector.

Furthermore, even though FIG. 1A shows only windows 110 and 112 as being disposed in the substrate support member 16, while other optical components are shown as external to the substrate support member 16, such depiction is partly illustrative, and partly for the sake of clarity in the figure. It is understood that one or more optical components, e.g., windows, optical fibers, lenses, photodetectors, among others, of the endpoint detection system 164 may also be disposed or embedded in the substrate support member 16, or be integrated with the optical access window 110 or 112. Other combinations of different optical measurements and configurations of signal detection can also be advantageously used for endpoint monitoring at two or more locations of the substrate.

In another embodiment, the use of an external light source 190, in conjunction with or in place of the plasma source, can expand the capabilities or provide advantages for transmittance measurements. For transmission mode, the external light source 190 will be coupled into the chamber 10 through a window 192 provided on the ceiling 13. The use of the external light source 190 for transmittance measurements has an advantage over the plasma source because it can provide a more stable signal than plasma emission, which may be subjected to fluctuations arising from the etch process. The external light source 190 may be configured to allow monitoring at selected wavelengths that are free from potential interferences from the plasma species. Similar to light source 166, the external light source 190 can also be operated in a pulsed mode to allow for various signal processing options for enhancing endpoint detection capabilities, e.g., by subtracting out possible fluctuations from plasma emission, and so on. Details for pulsed source operation with light source 190 are similar to those previously described for source 166. Other embodiments may involve the use of a pulsed source for both reflection and transmission measurements. In another embodiment, the external light source 190 may be provided through an optical access window (not shown) in the substrate support member 16, and the transmission signal monitored through the window 192.

As an example of reflectance monitoring, output from the light source 190 is coupled via a fiber 194 to pass through the window 192 onto the substrate 220 such as a photomask. Reflected light (e.g., off a feature on the photomask) is collected by a collimating lens 196 and coupled into another fiber 197 leading to a broadband spectrometer detector 198. The spectrometer 198 separates the light into its wavelength components, e.g., about 200 nm to 800 mm, to record a first spectrum.

A second spectrum is collected with the pulsed source off. This provides a background spectrum which can then be subtracted from the first spectrum. The difference spectrum, which includes contribution from the reflected light only, and will not be affected by plasma light. This sequence of collecting two spectra is repeated for each data point during the etch process. As a result, any changes in the plasma will not affect the measured reflectance, as might happen if the plasma emission is relatively intense.

Since the substrate (photomask) is a dielectric, e.g., transparent, the reflection measurement setup with background subtraction can be performed from either side of the substrate 220. That is, the fiber bundle and collimating optics can be placed on the ceiling 13 for collecting a signal from the substrate 220 through a ceiling window 192, or they can be placed below the substrate 220 for monitoring from the backside of the substrate.

The latter configuration of endpoint monitoring from below (i.e., through the substrate) offers at least two advantages. First, in the case of an absorbing layer being etched, such as Cr, the optical signal from the backside of the substrate will be less affected by changes in the thickness of the photoresist masking layer when viewed from below the substrate compared to viewing from above the substrate top surface. Second, for certain applications, a small optical sampling area is desired. For example, with quartz etch, interferometry is most accurate when measured within a designated test area with a uniform pattern. Thus, the use of backside monitoring in which the collimating optics are close to the substrate enables a smaller optical beam to be used than one that would originate from the ceiling of the chamber.

This subtraction technique can also be applied to transmission measurements, in which the light source and the detector are on opposite sides of the substrate being processed. This might entail a window in the ceiling and a window in the substrate holder, and separate optics for collection.

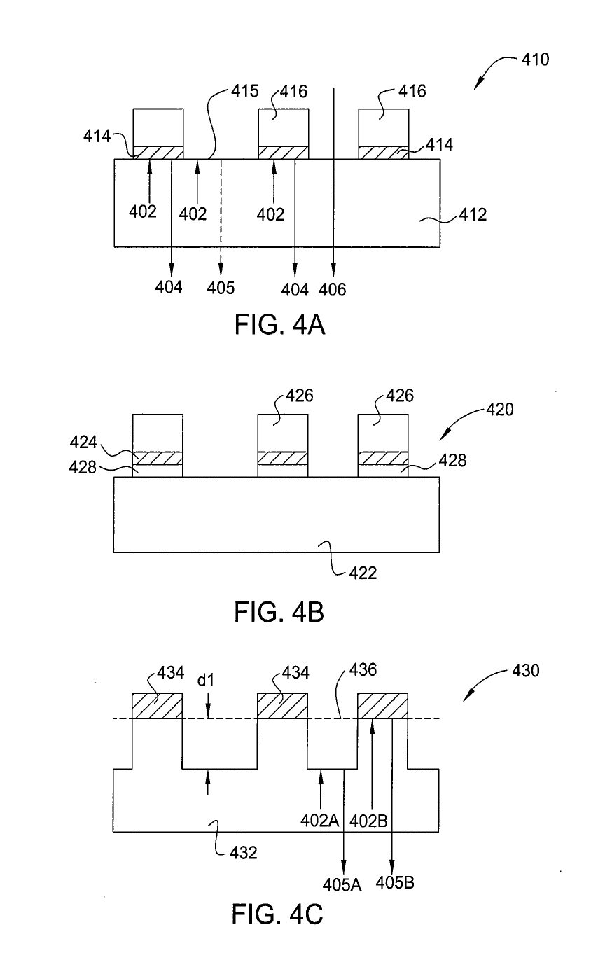

FIGS. 4A-C illustrate various structures during the fabrication of a photomask substrate that may be monitored by different endpoint detection techniques. FIG. 4A shows a binary photomask structure 410 with a patterned photoresist 416 for etching a metal-containing layer 414, e.g., a chrome layer comprising chromium oxide and chromium, which is disposed over a glass or quartz layer 412. The endpoint for etching the chrome layer 414 can be monitored either in reflection or transmission mode, and reflectance, transmittance and/or optical emission measurements can be performed.

For example, an incident optical beam 402 from the endpoint detection system 164 may be directed, through one of the windows in the substrate support member, onto one area of the photomask substrate 410. A return beam 404, arising from the interaction between the incident beam 402 and the photomask structure 410, e.g., reflecting off the back surface of chrome layer 414 (or interface between the chrome layer and the quartz layer), is detected by the photodetector 170 of the endpoint detection system 164. At the etch endpoint for the chrome layer 414, the reflectance signal decreases because the chrome layer in the open areas 415 (where there is no photoresist) of the photomask is removed, resulting in a loss of the reflected beam from these areas, as shown by the dashed arrow 405. Furthermore, diffraction analysis of the reflection spectrum may be performed to estimate the etch profile of a chrome feature, and to terminate the etch process when the foot of the chrome feature is cleared. Such analysis will allow the control of the etch profile of the feature.

In the transmission mode, the optical emission signal, e.g., from the plasma, passing through the open areas 415 is monitored. In one embodiment, the total intensity of the emission, i.e., the transmittance, may be measured. In another embodiment, the emission may be coupled to a wavelength dispersive element and signals monitored at one or more selected wavelengths. Towards the end of the chrome etch when the remaining chrome thickness is relatively small, the chrome thickness can also be estimated from the transmission signal.

FIG. 4B shows another photomask structure 420 during the fabrication of an attenuated phase shift mask. The structure 420 has a phase shifting material layer 428, e.g., molybdenum silicide (MoSi), formed over a quartz layer 422. A chrome layer 424 is deposited on top of the MoSi layer 428, followed by a photoresist layer 426. The photoresist layer 426 is patterned and used as an etch mask for the chrome layer 424. The molybdenum silicide (MoSi) layer can then be etched with either the patterned photoresist layer 426 acting as a mask, or with the patterned chrome layer 424 as a hardmask (after stripping of the photoresist layer 426). Similar to chrome etching, the endpoint for MoSi etching can be monitored in either reflection or transmission mode, and reflectance, transmittance, or optical emission measurement can be performed. Since MoSi is partially transmitting, interferometric measurements can also be used for endpoint monitoring.

FIG. 4C shows another mask structure 430 for fabrication a quartz phase shift mask, with a patterned chrome layer 434 serving as a hard mask for etching the underlying quartz layer 432. The original, or pre-etch, top surface 436 of the quartz substrate 432 is shown as a dashed line in FIG. 4C. In this case, the quartz layer 432 has to be etched down to a certain predetermined depth d₁ below the original surface 436. By operating the endpoint detection system 164 in reflection mode, the return beam 178 at a particular wavelength can be monitored as a function of time to provide interferometric data, e.g., the appearance of fringes arising from optical interference between different portions of the reflected beam 178 that travel through different thicknesses of a material layer. For example, one portion 402A of an incident optical beam is reflected off an open area of the photomask 430, while another portion 402B of the incident optical beam is reflected off a masked area of the photomask 430, e.g., an area with a chrome layer/feature 434. Interferences between the two reflected portions 405A and 405B produce interference fringes (i.e., intensity modulations) that are indicative of the difference in quartz layer thickness traversed by these portions 405A, 405B. By monitoring the interference fringes in the reflected beam, the etch depth d₁ can be obtained. In one embodiment, interferometric endpoint monitoring is performed in a pulsed mode, as previously described in connection with light source 166 in FIG. 1A. In general, any narrow band source may be suitable for interferometric monitoring. Thus, it is also possible to use the plasma as a light source for interferometric monitoring, as long as the plasma emission has a sufficiently narrow bandwidth for this purpose.

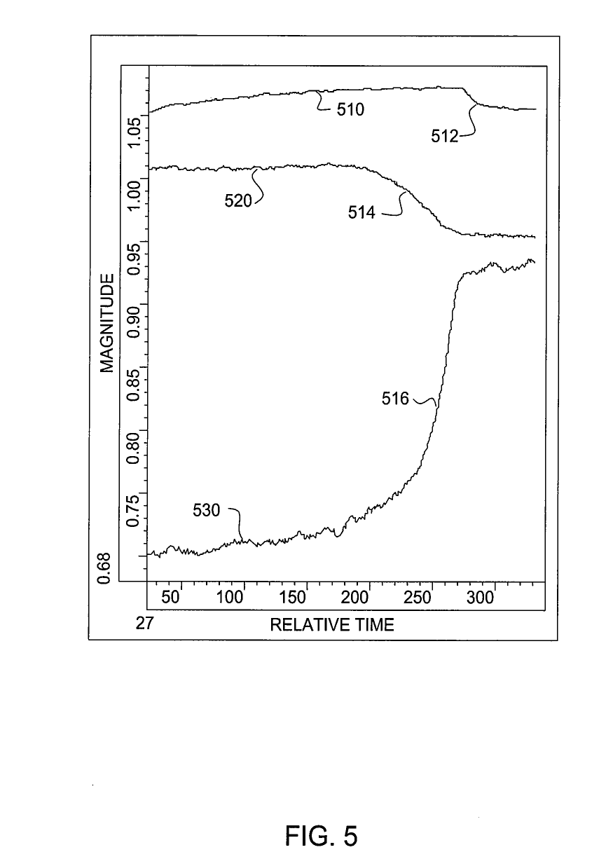

FIG. 5 shows three optical signals monitored simultaneously as a function of time during the etching of a Cr mask using the endpoint detection system. The chrome layer is etched using a plasma containing chlorine and oxygen gases. The top trace 510 is obtained by monitoring an emission signal originating from Cr, for example, either by directly monitoring an atomic line from Cr e.g., at a wavelength of 520 nm, or by monitoring the Cr emission line and a chlorine line (e.g., 258 nm) and taking a ratio of the Cr:Cl emission signals. Typically, the signal to noise can be improved by taking a ratio of emission signals of etch products to reactants (or vice versa). As the chrome etch approaches endpoint, the concentration of chromium-containing species (etch products) in the plasma decreases, resulting in a corresponding change in the Cr emission signal (or Cr:Cl emission ratio), as shown at point 512 of the top trace 510. In general, the optical emission signal can be monitored through one or more windows in chamber 10, e.g., those provided in the substrate support member 16 or in the ceiling, by looking directly at the plasma. In addition, a side window 193 may be provided in the chamber wall for detecting the plasma emission, for example, by coupling the emission to an optical emission detector system 195, as shown in FIG. 1A. The emission monitoring through the sidewall window 193 may be performed in conjunction with endpoint monitoring through one or more other windows.

The middle trace 520 is obtained by monitoring a reflection signal originating from light reflecting off the bottom surface of the chrome layer, similar to that shown in FIG. 4A. At the chrome etch approaches endpoint, the chrome layer in the open areas 415 of the mask becomes thinner as the chrome is etched away, which results in a decrease in the monitored reflectance signal intensity, as shown in the portion 514.

The bottom trace 530 is obtained by monitoring the transmittance. As shown in portion 516, the transmittance signal intensity increases towards endpoint when the chrome layer in the open areas 415 of the mask is removed, allowing the emission to be transmitted through the quartz layer in these areas.

The use of these optical measurement techniques, coupled with monitoring at two or more locations of the substrate, allows improved process control by providing enhanced endpoint detection. In one embodiment, the endpoint detection system is configured to operate in both the reflection and transmission modes. For example, referring back to FIG. 1A, a transmission signal (e.g., transmittance or plasma emission) is detected through window 112 for monitoring an area in the central region of the substrate, and a reflection signal (e.g., reflectance or interferometric) is detected through window 110 for monitoring an area in the peripheral region of the substrate. Monitoring the central region of the substrate in the transmission mode is advantageous because the alignment requirement between the etched features and the access window is less stringent than the reflection mode, and furthermore, a larger area can be monitored.

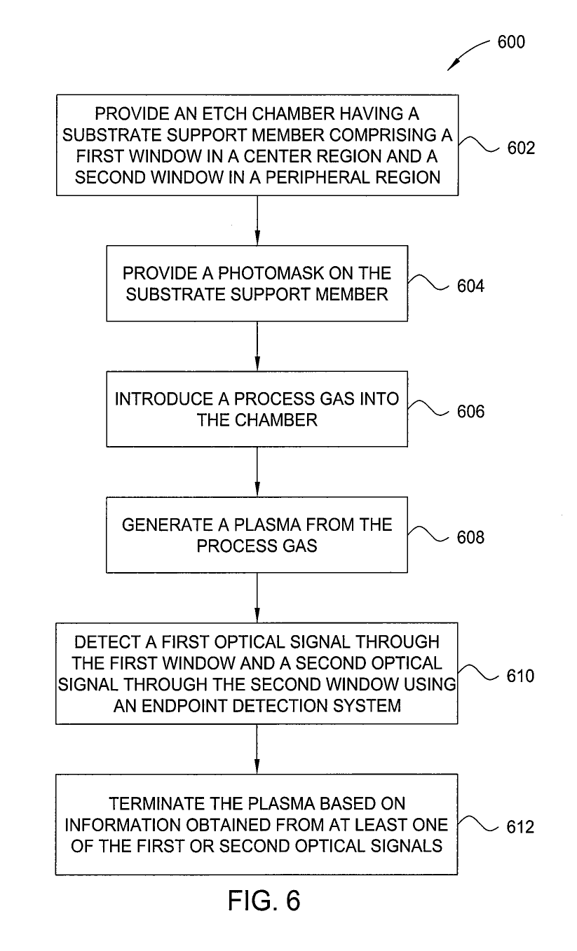

Thus, one embodiment of the present invention provides a method that can be implemented using the apparatus of this invention. In one embodiment, the apparatus of this invention includes a computer readable medium containing instructions, that when executed by the controller, such as the computer 172 or other processor suitable for controlling an etch reactor as commonly known in the art, cause an etch chamber to perform a method such as that shown in FIG. 6. It is contemplated that the computer readable medium may be stored in the memory of the computer 172, which also includes support circuits and processor. The method 600 starts at a step 602 where an etch chamber is provided with a substrate support member having a first window and a second window disposed respectively in a center region and a peripheral region of the support member. A photomask is provided on the support member in step 604, and a process gas is introduced into the chamber in step 606. Halogen-containing gases are typically used for etching different materials found on a photomask structure. For example, a process gas containing chlorine may be used for etching a chrome layer, while a fluorine-containing gas such as trifluoromethane (CHF₃) or tetrafluoromethane (CF₄) may be used for etching quartz. In step 608, a plasma is generated from the process gas, and in step 610, a first and second optical signals are detected through the first and second windows, respectively. In step 612, the plasma in the chamber is terminated based on information obtained from at least one of the two detected optical signals. Furthermore, based on the etch profile results such as center to edge uniformity, process parameters such as etchant gas composition, flow rate, coil bias, and so on, can be adjusted for optimization of the process.

By applying one or more optical measurement techniques for simultaneous monitoring at different locations of the substrate, embodiments of the present invention provide an improved apparatus and method with enhanced process monitoring and control capabilities. These improvements also allow reliable endpoint detection for photomask etching applications with low open areas. For example, optical emission endpoint detection has been demonstrated for etching photomasks with open areas down to about 3 percent for chrome and about 1 percent for molybdenum silicide, and reflectometry has been demonstrated for low open area chrome and quartz etching for phase shift mask applications. Aside from providing information for center to edge etch uniformity, etch rate variations arising from areas with different pattern densities can also be obtained by monitoring multiple optical signals using the endpoint detection system of the present invention. For example, test patterns with different feature size or pattern densities can be provided in different areas of the peripheral region of a photomask and the monitored optical signals can be used for assessing or determining the proper etch endpoint for pattern densities of interest.

It is also contemplated that a single window may be utilized in the substrate support to provide substrate monitoring. Particularly, features described above may be utilized with a single window to enhance substrate monitoring over conventional systems having a single window endpoint detector.

While the foregoing is directed to embodiments of the present invention, other and further embodiments of the invention may be devised without departing from the basic scope thereof, and the scope thereof is determined by the claims that follow.

1. An apparatus for substrate etching, comprising:
a plasma etching chamber;
a substrate support member inside the chamber, the substrate support member having a first window disposed in a center region and a second window disposed in a peripheral region; and
an endpoint detection system operatively coupled to the chamber through the first and second windows.

2. The apparatus of claim 1, wherein the endpoint detection system is configured for detecting a first optical signal through the first window and a second optical signal through the second window.

3. The apparatus of claim 2, wherein the first signal and the second signal are each selected from one of a reflectance, transmittance, interferometric signal and an optical emission signal.

4. The apparatus of claim 1, wherein the substrate is a photomask, and the second window is disposed at a distance of about 2.6 inches from a center of the substrate support member.

5. The apparatus of claim 1, wherein the substrate support member further comprises a third window in the peripheral region, and the second and third windows are disposed respectively at a corner and along a side of the peripheral region.

6. The apparatus of claim 1, wherein the endpoint detection system comprises:
a photodetector; and
means for directing at least one optical signal from inside the plasma etching chamber through one of the first and second windows to the photodetector.

7. The apparatus of claim 1, wherein the endpoint detection system comprises:
a light source;
a photodetector;
means for delivering a first optical beam from the light source to inside the plasma etching chamber through one of the first and second windows; and
means for directing a second optical beam returning from inside the plasma etching chamber to the photodetector through one of the first and second windows.

8. The apparatus of claim 7, wherein the means for delivering the first optical beam comprises a first optical fiber, and the means for receiving the second optical beam comprises a second optical fiber.

9. The apparatus of claim 8, wherein the second optical beam is formed by the first optical beam interacting with a substrate disposed on the substrate support member.

10. The apparatus of claim 1, wherein the endpoint detection system comprises:
a photodetector; and
means for directing light emission originating from inside the plasma etching chamber to the photodetector.

11. The apparatus of claim 10, wherein the endpoint detection system does not include a light source external to the plasma etching chamber.

12. The apparatus of claim 10, wherein the endpoint detection system further comprises a wavelength dispersive element having an input coupled to an optical fiber for receiving light emission from the plasma etching chamber and an output coupled to the photodetector.

13. The apparatus of claim 1, wherein the endpoint detection system is configured for operating in both a reflection mode and a transmission mode; and a first signal detected through the first window is a transmission signal and a second signal detected through the second window is a reflection signal.

14. An apparatus for substrate etching, comprising:
a plasma etching chamber comprising a substrate support member;
an endpoint detection system configured for operating in at least one of a reflection mode and a transmission mode;
wherein the endpoint detection system comprises a first optical component disposed in a center region of the substrate support member and a second optical component disposed in a peripheral region of the substrate support member.

15. The apparatus of claim 14, wherein each of the first and second optical components is selected from the group consisting of a window, a lens, a fiber, a filter, a photodetector, and combinations thereof.

16. An apparatus for substrate etching, comprising:
a plasma etching chamber;
a substrate support member inside the chamber, the substrate support member comprising a first window and a second window disposed therein, the first window being in a center region of the support member; and
an endpoint detection system operatively coupled to the chamber through one of the first and second windows.

17. The apparatus of claim 16, wherein the endpoint detection system comprising:
a light source configured for pulsed mode operation;
a photodetector;
means for delivering a first optical beam from the light source to inside the plasma etching chamber through one of the first and second windows; and
means for directing a second optical beam returning from inside the plasma etching chamber to the photodetector through one of the first and second windows.

18. An apparatus for substrate etching, comprising:
a plasma etching chamber;
a substrate support member inside the chamber, the substrate support member comprising at least a first window disposed in a center region of the support member;
a second window in a wall of the chamber; and
an endpoint detection system operatively coupled to the chamber through one of the first and second windows.

19. A method for etching a substrate, comprising:
(a) providing an etch chamber having a substrate support member, the substrate support member comprising at least a first window in a center region;
(b) providing a substrate on the substrate support member;
(c) introducing a process gas into the etch chamber;
(d) generating a plasma from the process gas for etching the substrate;
(e) detecting a first optical signal through the first window using an endpoint detection system; and
(f) terminating the plasma based on information obtained from at least one of the detected first and second optical signals.
